(19) United States
(12) Patent Application Publication
(10) Pub. No.: US 2022/0134592 A1
(43) Pub. Date: May 5, 2022

(54) CHAIN SAW

(71) Applicant: Nanjing Chervon Industry Co., Ltd., Nanjing (CN)

(72) Inventors: Toshinari Yamaoka, Nanjing (CN); Zhusheng Nie, Nanjing (CN); Xiaozhe Zhao, Nanjing (CN); Min Yi, Nanjing (CN); Zhaodi Ou, Nanjing (CN); Haodong Chen, Nanjing (CN)

(21) Appl. No.: 17/488,923

(22) Filed: Sep. 29, 2021

(30) Foreign Application Priority Data
Oct. 29, 2020 (CN) 202022460921.X

(51) Int. Cl. B27B 17/00; B27B 17/08; B27B 17/02

(52) U.S. Cl. CPC B27B 17/0058; B27B 17/02; B27B 17/08; B27B 17/0083

(57) ABSTRACT

A chain saw includes a connection rod and a front end assembly disposed at a front end of the connection rod. The front end assembly includes a motor, an output device, a transmission mechanism, and a front end casing. A ratio of rated output power P of the motor to a maximum weight of the chain saw is greater than or equal to 150 W/kg and less than or equal to 265 W/kg. The motor includes a rotor shaft, a rotor sleeve installed to the rotor shaft configured to rotate synchronously with the rotor shaft, a stator core disposed at least partially in the rotor sleeve, and a stator coil wound around the stator core.

### RELATED APPLICATION INFORMATION

This application claims the benefit under 35 U.S.C. § 119(a) of Chinese Patent Application No. CN 202022460921.X, filed on Oct. 29, 2020, which is incorporated by reference in its entirety herein.

### BACKGROUND

As a garden tool, a chain saw can be used for trimming branches. An object at a high or distant position can be cut by the chain saw. A connection rod of the chain saw is generally designed to be relatively long, and a front end of the chain saw is provided with a motor, a chain guide plate and the like and thus is relatively heavy so that a user has a relatively large load when using the chain saw and it is difficult for the user to hold the chain saw for a long time. In addition, the chain saw with an excessively large length is inconvenient for the user to precisely control the front end of the chain saw and trim a target object.

### SUMMARY

In one aspect of the disclosure, a chain saw includes a connection rod and a front end assembly. The front end assembly is disposed at a front end of the connection rod and includes a motor, an output device, a transmission mechanism, and a front end casing. The output device includes a guide plate and a chain wound around the guide plate, where the motor drives the chain to rotate. The transmission mechanism is configured to connect the motor to the output device.

The front end casing is configured to support the motor and the output device. A ratio of rated output power P of the motor to a maximum weight of the chain saw is greater than or equal to 150 W/kg and less than or equal to 265 W/kg. The motor includes a rotor shaft, a rotor sleeve, a stator core, and a stator coil. The rotor shaft is configured to rotate around a first axis. The rotor sleeve is installed to the rotor shaft and configured to rotate synchronously with the rotor shaft. The stator core is disposed at least partially in the rotor sleeve. The stator coil is wound around the stator core.

In some examples, the connection rod extends along a second axis, the chain saw has at least a first state, and in the case where the chain saw is in the first state, a ratio of a weight m2 of the front end assembly to a length L1 of the chain saw in a direction of the second axis is greater than or equal to 0.4 kg/m and less than or equal to 0.8 kg/m.

In some examples, the connection rod includes a first connection rod and a second connection rod, and in the case where the chain saw is in the first state, an extension rod is disposed between the first connection rod and the second connection rod.

In some examples, a diameter D1 of the rotor sleeve is less than or equal to 38 mm.

In some examples, the front end casing includes a first casing and a second casing. A first accommodation chamber and a second accommodation chamber are formed between the first casing and the second casing, the first accommodation chamber is used for accommodating the motor, and the second accommodation chamber is used for accommodating the transmission mechanism.

In some examples, the transmission mechanism includes a transmission gear and an output shaft. The transmission gear is driven to rotate by the motor. The output shaft is connected to the transmission gear, where a diameter D2 of the output shaft is configured to be greater than or equal to 8 mm and less than or equal to 12 mm.

In some examples, a transmission ratio outputted by the transmission mechanism is greater than or equal to 3.3 and less than or equal to 5.

In some examples, the chain saw includes a motor support. The motor support is configured to support the motor and includes two support arms arranged crosswise and clamped by the front end casing.

In some examples, a projection of the motor and a projection of the connection rod in a direction perpendicular to the first axis partially overlap.

In some examples, a weight of the motor is greater than or equal to 1.5 kg and less than or equal to 2 kg.

In some examples, a center of gravity of the chain saw is located on the connection rod, the connection rod extends along a second axis, and a maximum distance between the center of gravity and a rear end of the chain saw in a direction of the second axis is greater than or equal to 1100 mm and less than or equal to 1300 mm.

In some examples, the connection rod extends along a second axis, and the second axis and the first axis are parallel to or coincide with each other.

In some examples, the chain saw includes a rear end casing, where the connection rod connects the front end assembly to the rear end casing.

In some examples, the rear end casing includes a handle and a battery pack interface. The handle is for a user to hold. The battery pack interface is configured to be connected to a power supply or a battery pack.

In another aspect of the disclosure, a chain saw includes a connection rod and a front end assembly. The front end assembly is disposed at a front end of the connection rod and includes a motor, an output device, a transmission mechanism, and a front end casing. The output device includes a guide plate and a chain wound around the guide plate, where the motor drives the chain to rotate. The transmission mechanism is configured to connect the motor to the output device. The front end casing is configured to support the motor and the output device. A diameter of the motor is less than or equal to 38 mm; and a ratio of rated output power P of the motor to a maximum weight of the chain saw is greater than or equal to 150 W/kg and less than or equal to 265 W/kg.

In an additional aspect of the disclosure, a chain saw includes a connection rod and a front end assembly. The front end assembly is disposed at a front end of the connection rod and includes a motor, an output device, a transmission mechanism, and a front end casing. The output device includes a guide plate and a chain wound around the guide plate, where the motor drives the chain to rotate. The transmission mechanism is configured to connect the motor to the output device. The front end casing is configured to support the motor and the output device. The motor includes a rotor shaft, a rotor sleeve, a stator core, and a stator coil. The rotor shaft is configured to rotate around a first axis. The rotor sleeve is installed to the rotor shaft and configured to rotate synchronously with the rotor shaft, where a diameter D1 of the rotor sleeve is less than or equal to 38 mm. The stator core is disposed at least partially in the rotor sleeve. The stator coil is wound around the stator core.

The beneficial effects are that through the configuration of the motor in structure and the entire chain saw in the present disclosure, the operation distance of the chain saw can be increased without reducing the performance, and the load held by the user can be reduced so that the chain saw is convenient for the user to operate.

### BRIEF DESCRIPTION OF DRAWINGS

FIG. 1 is a perspective view of a chain saw according to a first example of the present disclosure;

FIG. 2 is a perspective view of a front end assembly of the chain saw in FIG. 1;

FIG. 3 is a sectional view of a front end assembly of the chain saw in FIG. 1;

FIG. 4 is a view of an internal structure of a front end assembly of the chain saw in FIG. 1;

FIG. 5 is a sectional view of a front end mechanism of the chain saw in FIG. 1;

FIG. 6 is a plan view of the chain saw in FIG. 1;

FIG. 7 is a view of structures inside a rear end casing of the chain saw in FIG. 1;

FIG. 8 is a view of an internal structure of a front end mechanism of the chain saw in FIG. 1;

FIG. 9 is a view of an internal structure of a front end mechanism of the chain saw in FIG. 1;

FIG. 10 is a plan view of a front end mechanism of the chain saw in FIG. 1;

FIG. 11 is an internal schematic view of a front end mechanism of the chain saw in FIG. 1;

FIG. 12A is a plan view of a front end mechanism of the chain saw in FIG. 1;

FIG. 12B is an internal schematic view of a front end mechanism of the chain saw in FIG. 1 with an auxiliary casing removed;

FIG. 13 is a schematic view of a dimension of the chain saw in FIG. 1;

FIG. 14 is a structure view of a chain saw according to an example of the present disclosure;

FIG. 15 is a perspective view of a chain saw according to an example of the present disclosure;

FIG. 16 is a schematic view of a head structure of the chain saw in FIG. 15;

FIG. 17 is a sectional view of the chain saw in FIG. 15 with a chain tensioning element at a first installation position;

FIG. 18 is a sectional view of the chain saw in FIG. 15 with a chain tensioning element at a second installation position;

FIG. 19 is an exploded view of the head structure of the chain saw in FIG. 16;

FIG. 20 is an enlarged view of a positioning hole of the chain saw in FIG. 19;

FIG. 21 is a plan view of a chain tensioning element and a locking piece of the chain saw in FIG. 15;

FIG. 22 is a sectional view of a first cross section and a second cross section of the chain tensioning element of the chain saw in FIG. 21; and

FIG. 23 is a plan view of a chain tensioning element and a locking piece of a chain saw according to an example of the present disclosure.

### DETAILED DESCRIPTION

A chain saw 100 of the present disclosure is a commonly used garden tool, may be a chain saw or a long pole chain saw, and may be configured to trim branches and the like. The present disclosure is described below in detail in conjunction with drawings and examples.

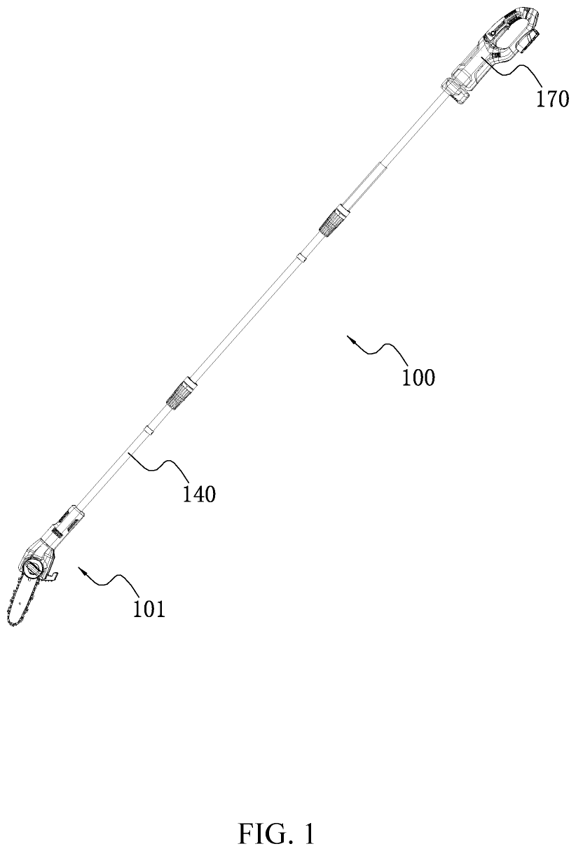

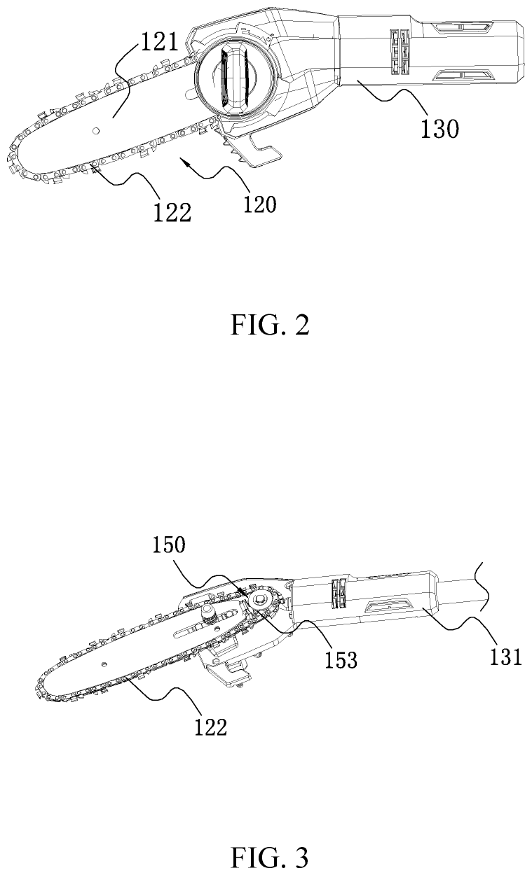

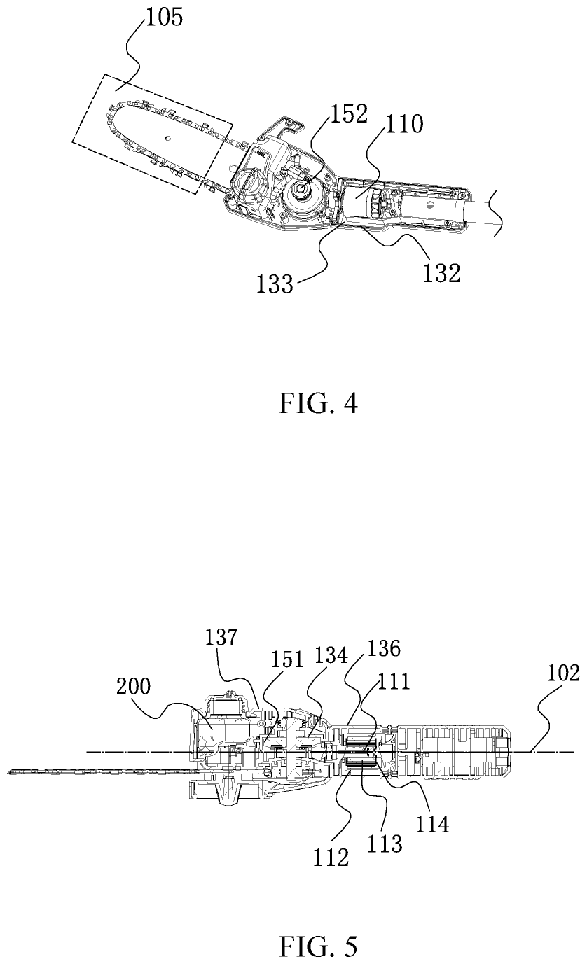

Referring to FIGS. 1 to 5, using the long pole chain saw as an example, the chain saw 100 includes a front end assembly 101 and a connection rod 140. The front end assembly 101 is configured to output an operation and disposed at a front end of the connection rod 140.

The front end assembly 101 includes a motor 110, an output device 120, and a front end casing 130. The output device 120 includes a guide plate 121 and a chain 122 wound around the guide plate 121. The motor 110 includes a motor shaft 111 rotatable around a first axis 102. The motor shaft 111 rotates to drive the chain 122 to rotate, thereby performing a cutting operation. The front end casing 130 is configured to support the motor 110 and the output device 120 and disposed at the front end of the connection rod 140, and the connection rod 140 is a long rod with a certain length so that a user can deliver the chain 122 to the branches or other distant positions to achieve the cutting operation.

The chain saw 100 further includes a transmission mechanism 150, and the transmission mechanism 150 is configured to connect the motor 110 to the output device 120. The front end casing 130 includes a first casing 131 and a second casing 132. A first accommodation chamber 133 and a second accommodation chamber 134 are formed between the first casing 131 and the second casing 132. The first accommodation chamber 133 is used for accommodating the motor 110, and the second accommodation chamber 134 is used for accommodating the transmission mechanism 150. The first casing 131 and the second casing 132 form a two-half casing structure of the front end casing 130, and the motor 110 and the transmission mechanism 150 are clamped by mating the first casing 131 with the second casing 132. That is, a gear box for fixing the transmission mechanism 150 is formed by both the first casing 131 and the second casing 132 mating with each other so that the gear box and the front end casing 130 are integrally formed without a separate gear box for fixing the transmission mechanism 150. In this manner, a dimension and a weight of the front end assembly 101 can be reduced.

The second accommodation chamber 134 is disposed in the front end casing 130. The transmission mechanism 150 includes a transmission gear 151, an output shaft 152, and a sprocket 153. The transmission gear 151 may be configured to be a bevel gear, an end of the motor shaft 111 is configured to be a conical structure fitting with the transmission gear 151, and the transmission gear 151 meshes with the end of the motor shaft 111 of the motor 110. The transmission gear 151 and the output shaft 152 are connected to be rotatable synchronously. The output shaft 152 drives the sprocket 153 to rotate, and the chain 122 is driven by the sprocket 153 to move on the guide plate 121.

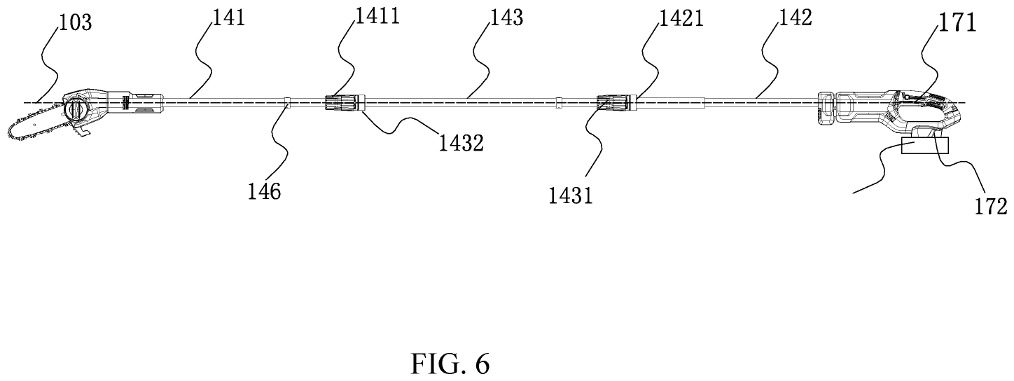

Referring to FIGS. 1 and 6, the chain saw 100 further includes a rear end casing 170 formed with a handle 171 and a battery pack interface 172. The handle 171 is for the user to hold and has a D-shaped structure. The handle 171 is formed with a holding opening, and the user can hold the handle 171 with fingers passing through the holding opening. The handle 171 is disposed at an end of the connection rod 140 such that the connection rod 140 is relatively disposed on a side of the handle 171. The battery pack interface 172 is used for installation of a battery pack 173. The battery pack 173 can supply power to the motor 110. The battery pack 173 is detachably installed to the battery pack interface 172. When the battery pack 173 is installed to the battery pack interface 172, the battery pack 173 is disposed below the handle 171 and the handle 171 is connected to the battery pack interface 172. Optionally, the battery pack interface 172 and the handle 171 are integrally formed. The chain saw 100 is generally configured to perform the cutting operation on an object at a distant or high position, has a certain length, and is relatively heavy. The handle 171 is disposed at the end of the connection rod 140 so that the length of the connection rod 140 can be fully utilized, and the design of the D-shaped handle 171 allows the user to hold the handle 171 stably, thereby cutting the object at the high position for a long time.

The connection rod 140 is configured to connect the front end assembly 101 to the handle 171, and the connection rod 140 has a second axis 103 passing through an inside of the connection rod 140 and is configured to extend along the second axis 103 of the connection rod 140.

Optionally, the connection rod 140 includes a first connection rod 141, a second connection rod 142, and an extension rod 143. The first connection rod 141 and the second connection rod 142 are detachably connected, and the extension rod 143 is detachably connected between the first connection rod 141 and the second connection rod 142. When the extension rod 143 is connected between the first connection rod 141 and the second connection rod 142, a length of the chain saw 100 along the first axis 102 is greater than or equal to 2.4 m and less than or equal to 3.2 m. That is, through the cooperation of the first connection rod 141 and the second connection rod 142, the chain saw 100 can achieve two operation states. In a first state, the extension rod 143 is disposed between the first connection rod 141 and the second connection rod 142 so that the chain saw 100 has a maximum length. In a second state, the first connection rod 141 is directly connected to the second connection rod 142 so that the chain saw 100 is relatively light. The user may choose whether to install the extension rod 143 according to operation requirements, so that the operation is more convenient when working in a long distance, and the load reduction when cutting a relatively close object.

The motor 110 further includes a rotor sleeve 112, a stator core 113, and a stator coil 114. The rotor sleeve 112 is installed to a rotor shaft 111 and configured to rotate synchronously with the rotor shaft 111. Two ends of the rotor shaft 111 pass through the rotor sleeve 112. The stator core 113 is disposed at least partially in the rotor sleeve 112 and used for the stator coil 114 to be wound around. A diameter D1 of the rotor sleeve 112 is less than or equal to 38 mm and greater than or equal to 30 mm. Specifically, D1 may be less than or equal to 36 mm and greater than or equal to 32 mm and is most preferably 34 or 35 mm. In this manner, a volume and a weight of the motor 110 can be reduced so that the dimension of the entire machine is optimized and it is convenient for the user to operate the long pole chain saw 100. As a dimension of the motor 110 is reduced, a dimension of the transmission mechanism 150 may be correspondingly reduced. A diameter D2 of the output shaft 152 is configured to be greater than or equal to 8 mm and less than or equal to 12 mm, and a transmission ratio outputted by the transmission mechanism 150 is greater than or equal to 3.3 and less than or equal to 5. Through transmission of the transmission mechanism 150, the output shaft 152 rotates at a rotation speed lower than a rotation speed of the motor 110 and a torque provided by the output shaft 152 is increased. The dimensions of the motor 110 and the transmission mechanism 150 are reduced so that dimensions of the first accommodation chamber 133 and the second accommodation chamber 134 used for accommodating the motor 110 and the transmission mechanism 150 can be correspondingly reduced, and a weight of the front end casing 130 can be reduced, thereby reducing the volume and weight of the front end casing 130.

Therefore, while rated output power of the motor 110 is satisfied, the diameter of the rotor sleeve 112 is reduced so that the diameter D1 of the rotor sleeve 112 is less than or equal to 38 mm and greater than or equal to 30 mm; and the weight of the motor 110 is greater than or equal to 1.5 kg and less than or equal to 2 kg so that a ratio of the rated output power P of the motor 110 to a maximum weight m1 of the chain saw 100 is greater than or equal to 190 W/kg and less than or equal to 240 W/kg. The maximum weight m1 of the chain saw 100 refers to a weight of the entire machine when the battery pack 173 is not installed to the chain saw. The maximum weight m1 of the chain saw 100 refers to a weight of the chain saw 100 in the first state, that is, a weight of the entire machine when the extension rod 143 is installed. Optionally, the rated output power P of the motor 110 is configured to be greater than or equal to 600 W and less than or equal to 960 W, and a ratio of the rated output power P of the motor 110 to a voltage of the motor 110 is configured to be greater than or equal to 24 W/V and less than or equal to 38.5 W/V.

The connection rod 140 extends along the second axis 103. In this example, the second axis 103 and the first axis 102 are parallel to or coincide with each other. That is, the motor 110 is disposed in the front end casing 130 in a direction of the second axis 103. When the chain saw 100 is in the first state, a ratio of a weight m2 of the front end assembly 101 to a length L1 of the chain saw 100 in the direction of the second axis 103 is greater than or equal to 0.4 kg/m and less than or equal to 0.8 kg/m. The weight of the front end assembly 101 is configured to be greater than or equal to 1.4 kg and less than or equal to 1.9 kg. Optionally, the weight of the front end assembly 101 is configured to be greater than or equal to 1.6 kg and less than or equal to 1.7 kg. The weight of the motor 110 is reduced so that a front end of the long pole chain saw 100 is effectively made relatively light, and the user can lift the entire machine with less efforts, thereby reducing fatigue of the user when operating the long pole chain saw 100, effectively extending the time for which the user operates the chain saw 100 continuously, and improving operation comfort and operation efficiency.

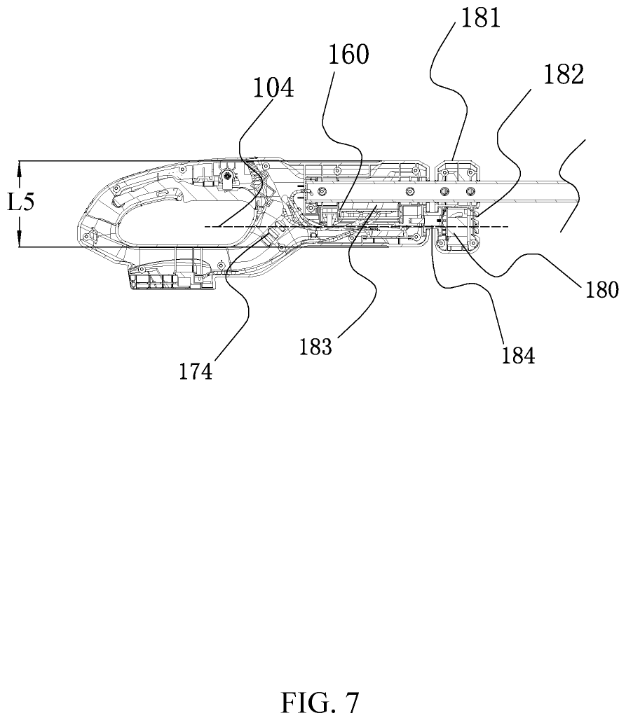

As shown in FIGS. 1 and 7, the chain saw 100 further includes a controller 160 and a driver circuit, and the controller 160 is specifically a circuit board. The controller 160 is configured to control the motor 110 to rotate and electrically connected to the motor 110. The controller 160 is disposed in the rear end casing 170. The controller 160 is connected to the battery pack 173 and the motor 110 through the driver circuit, so as to control the motor 110 to operate.

The chain saw 100 further includes a fan 180 and a fan casing 181. The fan 180 rotates around a fan axis and is configured to dissipate heat inside the rear end casing 170, thereby alleviating the temperature rise generated by the controller 160 when the chain saw 100 is operating. The fan casing 181 is used for accommodating the fan 180. The fan casing 181 is disposed opposite to the rear end casing 170. The fan 180 can generate a heat dissipation airflow inside the rear end casing 170, and the heat dissipation airflow flows through the controller 160, thereby reducing the temperature of the controller 160 in operation.

The connection rod 140 passes through the fan casing 181 and extends into the rear end casing 170. The fan casing 181 is disposed around the connection rod 140. The fan casing 181 is independent of the rear end casing 170, and the fan casing 181 is spaced apart from the rear end casing 170 by a certain distance in the direction of the second axis 103. An air duct 184 is disposed between the fan casing 181 and the rear end casing 170 and connected to the fan casing 181 and the rear end casing 170. An included angle between the fan axis and a projection of the second axis on a plane where the guide plate is located is greater than or equal to 0 degrees and less than or equal to 30 degrees, thereby increasing a volume of the heat dissipation airflow passing through the controller 160. The rear end casing 170 includes a connection opening, and the air duct 184 is connected to the connection opening, where the connection opening is disposed between the fan 180 and the controller 160. Optionally, the air duct 184 is configured to extend along a first straight line. At this time, an included angle between the fan axis extending along the first straight line 104 and a projection of the first straight line 104 on the plane where the guide plate 121 is located is greater than or equal to 0 degrees and less than or equal to 30 degrees, thereby increasing the volume of the heat dissipation airflow passing through the controller 160. The first straight line 104 and the second axis 103 are parallel to each other. The fan 180 may be a suction fan 180 or a blowing fan 180. A distance between the fan casing 181 and the connection opening is configured to be less than or equal to 40 mm. Optionally, the first straight line 104 passes through the connection opening, the fan 180, and the controller 160 so that part of the airflow generated by the fan 180 can flow in parallel with a surface of the controller 160, thereby improving the efficiency of heat dissipation inside of the rear end casing 170. Optionally, the fan axis is parallel to the first straight line 104 so that the fan 180 is configured to face the connection opening and the fan 180 faces the controller 160. Optionally, the air duct 184 is a plastic duct.

The chain saw 100 further includes a heat sink 183. The heat sink 183 is in direct or indirect contact with the connection rod 140. The heat sink 183 is in contact with the controller 160 to form a bonding surface. An area of the bonding surface is configured to be greater than or equal to 2000 mm² and less than or equal to 3000 mm², so as to increase an effective heat dissipation area of the controller as much as possible and prevent too complicated a structure in the rear end casing. The rear end casing 170 includes an accommodation portion. The heat sink 183 and the controller 160 are disposed in the accommodation portion, and part of the connection rod 140 extends into the accommodation portion, which improves the heat dissipation effect and makes the rear end casing 170 more compact. Optionally, both the battery pack interface 172 and the heat sink 183 are disposed below the connection rod 140, and the second axis 103 along which the connection rod 140 extends passes through the handle 171 so that the balance of the user in holding the handle 171 to operate the chain saw 100 is improved and it is convenient for the user to perceive a relative position of the connection rod 140. In this manner, operation accuracy is improved.

The rear end casing 170 includes a first vent 174, the fan casing 181 includes a second vent 182, and the first straight line 104 passes through the first vent 174 and the second vent 182. The airflow generated by the fan 180 flows in from the first vent 174, through the controller 160, and out from the second vent 182. Optionally, the airflow generated by the fan 180 flows in from the second vent 182, through the controller 160, and out from the first vent 174.

The first vent 174 is disposed at a front end of the handle 171 and on a side surface of the rear end casing 170, and the second vent 182 is formed at a front end of the fan casing 181. Here, it is defined that the motor 110 is relatively disposed in front of the rear end casing 170. An end cover is further included on a side of the first vent 174 so that in a direction of an opening of the first vent 174 facing away from the handle 171, the end cover guides the airflow to a front side, thereby preventing too hot an airflow from blowing to the user and improving user experience. Optionally, a certain plane where the first straight line 104 is located passes through the first vent 174 and the second vent 182, thereby reducing the turbulence of the airflow in the rear end casing 170 and improving heat dissipation efficiency. In the preceding structure, as shown in FIG. 7, a distance L5 between upper and lower side surfaces of the accommodation portion may be configured to be greater than or equal to 87 mm and less than or equal to 90 mm.

The guide plate 121 extends along a first plane 105. In the preceding structure, a shortest distance L3 between the second axis 103 and the guide plate 121 is greater than or equal to 16 mm and less than or equal to 17 mm so that it is convenient for the user to turn the chain saw 100. In addition, a cutting surface is closer to a center line of the handle 171 so that it is convenient for the user to know a position of the cutting surface where the guide plate 121 is located and operate the chain saw 100.

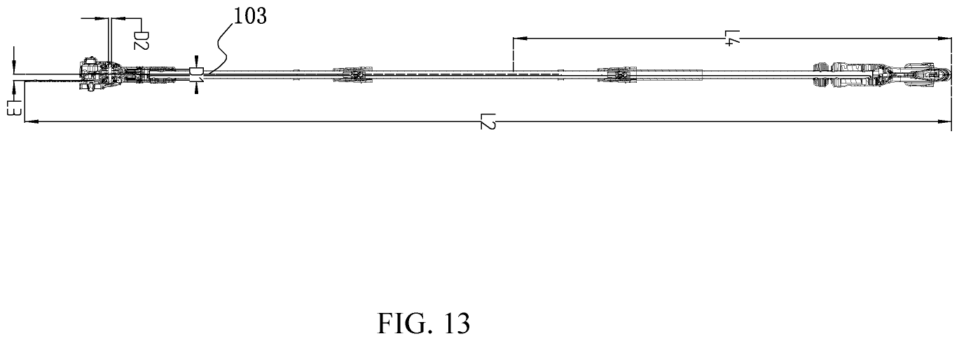

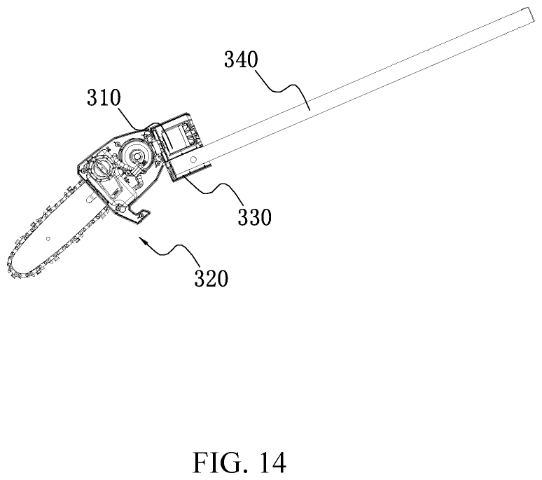

As shown in FIG. 13, a center of gravity of the chain saw 100 is located on the connection rod 140, and the connection rod 140 extends along the second axis 103. In the direction of the second axis 103, a maximum distance L4 between the center of gravity and a rear end of the chain saw 100 is greater than or equal to 1100 mm and less than or equal to 1300 mm, and the center of gravity is closer to the handle 171, thereby improving the holding stability of the user.

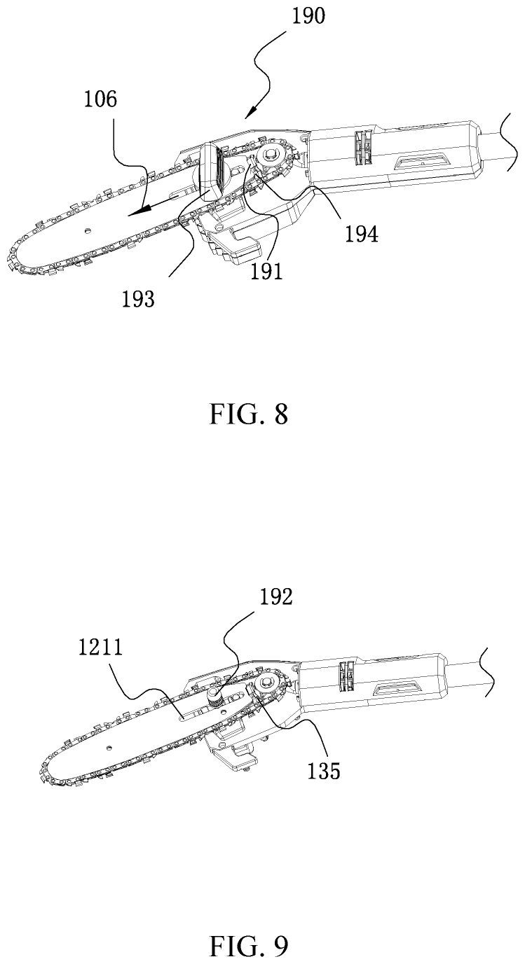

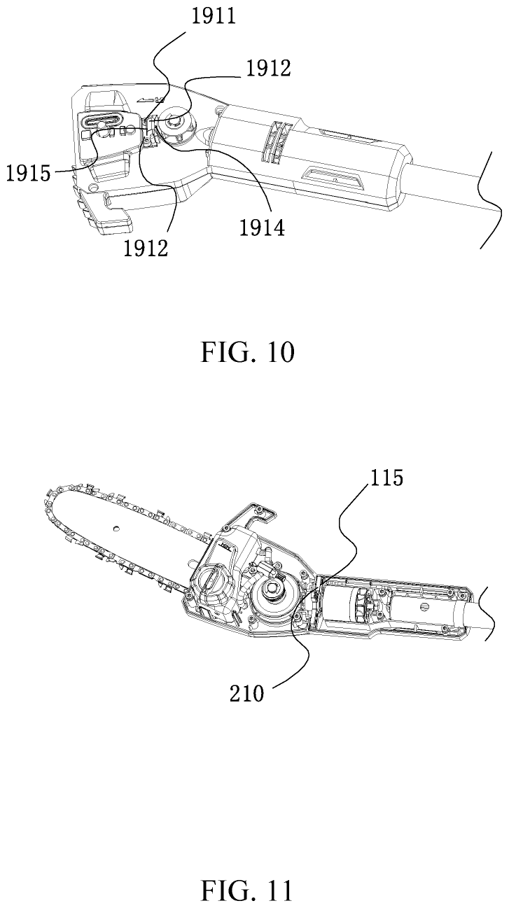

As shown in FIG. 1 and FIGS. 8 to 10, the chain saw 100 further includes a chain tensioning assembly 190. The chain tensioning assembly 190 can automatically adjust a gap between the chain 122 and the guide plate 121, thereby improving the adaptability of the chain 122 to the guide plate 121 and improving cutting efficiency. The chain tensioning assembly 190 includes a first limiting piece 191 and a fixing piece 1911. The first limiting piece 191 stores a driving force for driving the guide plate 121 to have a tendency of moving away from the sprocket 153 toward a first direction 106. The fixing piece 1911 is configured to connect the first limiting piece 191 to the front end casing 130, and the first limiting piece 191 can be relatively fixed to the front end casing 130 in at least one direction through the fixing piece 1911. The chain tensioning assembly 190 further includes a bolt 192 and an operation piece 193, and the bolt 192 can provide a pressing force for connecting the guide plate 121 to the front end casing 130. The operation piece 193 is connected to the bolt 192 to adjust the pressing force provided by the bolt 192.

The guide plate 121 extends along the first plane 105, and the bolt 192 is configured to press the guide plate 121 against the front end casing 130 in a direction perpendicular to the first plane 105. The operation piece 193 rotates the bolt 192 to adjust the pressing force provided by the bolt 192 to the guide plate 121 and the front end casing 130. Optionally, the first limiting piece 191 is an elastic piece. When the guide plate 121 is installed to the front end casing 130 and fixed to the front end casing 130 by the bolt 192, a rear end of the guide plate 121 is in contact with and presses the first limiting piece 191. The user loosens the bolt 192 through the operation piece 193 so that the bolt 192 no longer limits the displacement of the guide plate 121. The elastic first limiting piece 191 pushes the guide plate 121 away from the sprocket 153 in the first direction 106 due to the elasticity of the first limiting piece 191, that is, the first limiting piece 191 pushes the guide plate 121 to press the chain 122, and the chain 122 installed on sides of the sprocket 153 and the guide plate 121 reacts on the guide plate 121 and the first limiting piece 191 so that the three are adaptively adjusted to a balanced state. At this time, the user makes the bolt 192 press the guide plate 121 against the front end casing 130 through the operation piece 193, so as to adjust a tension state of the chain 122. The elastic first limiting piece 191 can automatically adjust a bonding state of the chain 122 to the guide plate 121, and the user does not need to manually adjust the tension state between the chain 122 and the guide plate 121, thereby improving the use efficiency and cutting performance of the chain saw 100.

The first limiting piece 191 includes a connection portion 1912 and an abutting portion 1913, and the connection portion 1912 is connected to the front end casing 130 through the fixing piece 1911. The abutting portion 1913 is formed with a limiting surface 1915 in a direction toward the guide plate 121. When the guide plate 121 is installed to the front end casing 130, the limiting surface 1915 abuts against a side surface of the guide plate 121, and the limiting surface 1915 moves in the first direction 106 with elastic deformation of the first limiting piece 191. Optionally, the connection portion 1912 and the abutting portion 1913 form an L-shape, the connection portion 1912 is configured to be bonded to a surface of the front end casing 130, and the abutting portion 1913 protrudes relative to the front end casing 130.

The chain tensioning assembly 190 has a first limiting state and a second limiting state. When the chain tensioning assembly 190 is in the first limiting state, the first limiting piece 191 supports the guide plate 121; when the chain tensioning assembly 190 is in the second limiting state, the first limiting piece 191 and a second limiting piece 194 jointly support the guide plate 121.

During the early use of the first limiting piece 191, the first limiting piece 191 can provide a relatively large biasing force. At this time, the first limiting piece 191 independently supports the guide plate, and the second limiting piece 194 is not in contact with the guide plate. In the process of using a traditional chain saw for a long time, the first limiting piece 191 produces excessive elastic deformation so that the chain 122 cannot be fully tensioned relative to the guide plate 121. At this time, the chain 122 is installed and the first limiting piece 191 cannot effectively limit the guide plate 121 in the first direction 106 so that the chain saw 100 is prone to shaking and abrasion during operation. Therefore, the chain tensioning assembly 190 is further provided with the second limiting piece 194. When the guide plate 121 is installed to the front end casing 130, a distance between the second limiting piece 194 and the guide plate 121 is less than a distance between the first limiting piece 191 and the guide plate 121 in the first direction 106. After the elastic deformation of the first limiting piece 191 exceeds a certain level, plastic deformation occurs. At this time, the chain tensioning assembly is in the second limiting state, and the second limiting piece 194 and the first limiting piece 191 simultaneously limit the guide plate 121, thereby reducing the shaking of the chain saw 100 during operation.

Optionally, the second limiting piece 194 is disposed on both sides of the first limiting piece 191 and disposed between the guide plate 121 and the sprocket 153, thereby improving the support stability of the guide plate 121 by the second limiting piece 194. An elastic modulus of the second limiting piece 194 is less than an elastic modulus of the first limiting piece 191. When the guide plate 121 is installed to the front end casing 130, the first limiting piece 191 abuts against the guide plate 121, and a distance L2 between the second limiting piece 194 and the guide plate 121 in the first direction 106 is greater than or equal to 0.1 mm and less than or equal to 0.35 mm, thereby reducing the interference of the second limiting piece 194 on the adjustment of a tensioning force of the first limiting piece 191 in a normal state. In this manner, while excessive elastic deformation of the first limiting piece 191 can be effectively reduced, the position setting of the second limiting piece 194 can limit the guide plate 121.

The guide plate 121 further includes a center hole 1211 extending in the first direction 106, and the front end casing 130 further includes a limiting pin. When the guide plate 121 is installed to the front end casing 130, the limiting pin passes through the center hole 1211, and a width of the center hole 1211 fits with a dimension of the limiting pin so that when the guide plate 121 is installed to the front end casing 130, the limiting pin is in the center hole 1211, and thus the guide plate 121 can only move in the first direction 106.

The front end casing 130 further includes a stop 135, and the stop 135 is disposed between the sprocket 153 and the first limiting piece 191. The first limiting piece 191 further includes a hook 1914, and the hook 1914 is disposed facing away from the limiting surface 1915 and connected to the stop 135. The fixing piece 1911 is fixedly connected to the front end casing 130 and the hook 1914 is clamped to the stop 135 so that the first limiting piece 191 is fixed relative to the front end casing 130 in two directions, thereby improving the stability of the first limiting piece. The fixing piece 1911 may be a screw so that the first limiting piece 191 is detachable relative to the front end casing 130, and thus the first limiting piece 191 is replaceable. The stop 135 is formed with a slot for supporting the second limiting piece 194, and part of the second limiting piece 194 is placed in the stop 135, thereby fixing the second limiting piece 194 more strongly.

The chain saw 100 further includes an oil supply assembly, and the oil supply assembly includes an oil can 200, an oil pump, and an oil pipe. The oil can 200 is configured to store machine oil for lubricating the transmission mechanism 150 and the chain 122. The oil pipe is configured to connect the oil can to the oil pump, and the oil pump draws the machine oil from the oil can 200 and transports the machine oil to the transmission mechanism 150 through the oil pipe, thereby lubricating the chain 122 and the guide plate 121. The oil pump includes a plunger, and the plunger is connected to the transmission mechanism 150 and can be driven by the transmission mechanism 150. When the chain saw 100 is operating, the transmission mechanism 150 drives the plunger to reciprocate so that the oil pump draws the machine oil from the oil can 200 and outputs the machine oil to the chain 122.

A capacity of the oil can 200 is greater than or equal to 80 mL and less than or equal to 135 mL, and a capacity of the battery pack 173 is configured to be greater than or equal to 1.5 AH. When the rated output power of the motor 110 is greater than or equal to 600 W and less than or equal to 960 W, a ratio of a maximum oil supply time of the oil can 200 to an endurance time of the battery pack 173 is greater than or equal to 2 and less than or equal to 5. The maximum oil supply time of the oil can 200 refers to an accumulated time for which the machine oil accommodated in the oil can 200 filled with the machine oil can lubricate the transmission mechanism 150 when chain saw 100 is operating. Here, the endurance time of the battery pack 173 refers to a total time for which a fully charged battery pack can supply power to a power tool in operation when the rotation speed of the motor is greater than or equal to 19500 rpm and less than or equal to 25500 rpm and the motor is free of load.

The oil supply assembly further includes a duckbill valve disposed at an oil outlet of the oil pipe. When the oil pump is operating, a pressure difference exists in the oil pipe. At this time, the duckbill valve is opened to allow the machine oil to flow. When the oil pump is not driven by the motor to start, the duckbill valve is closed to prevent the machine oil in the oil pipe from flowing out, thereby preventing oil leakage when the chain saw is not in use.

The front end casing 130 further includes a fixing portion configured to fix the oil can 200. The diameter D1 of the rotor sleeve 112 is less than or equal to 38 mm, and the dimension and weight of the motor 110 and the dimension and weight of the transmission mechanism 150 are reduced so that the capacity of the oil can 200 can be increased and the front end of the chain saw 100 is prevented from being too heavy to be inconvenient for the operation of the user. The ratio of the maximum oil supply time of the oil can 200 to the endurance time of the battery pack 173 can be greater than or equal to 2 and less than or equal to 5. That is, the user needs to add the machine oil to the oil can 200 once only after using more than two battery packs 173, thereby avoiding frequent addition of the machine oil. Optionally, the ratio of the maximum oil supply time of the oil can 200 to the endurance time of the battery pack is configured to be an integer so that the oil can 200 is added at the same time as the battery pack 173 is replaced. In this manner, the user can add the machine oil while replacing the battery pack 173, and the case where the oil can 200 with no machine oil cannot effectively lubricate the transmission mechanism 150 when the chain saw 100 is in use can be reduced, reducing the abrasion of the transmission mechanism 150 and increasing the service life of the chain saw 100.

The first connection rod 141 is connected to the front end assembly 101 and includes a first installation piece 1411. The second connection rod 142 is connected to the handle 171 and includes a first connection base 1421. The first installation piece 1411 is operable to be connected to or disconnected from the first connection base 1421. A second installation piece 1431 configured to be connected to the first connection base 1421 is disposed at an end of the extension rod 143, and a second connection base 1432 configured to be connected to the first installation piece is disposed at the other end of the extension rod 143. The first connection rod 141 and the extension rod 143 further include hoops 146. The hoops 146 are respectively disposed on the first connection rod 141 and the extension rod 143, and at least part of an installation piece 144 is limited between the hoops 146 so that the first installation piece 1411 and the second installation piece 1431 can be prevented from being detached from the connection rod 140 or sliding to a position farther from a connection position of the connection rod 140, which is convenient for the user to operate.

As shown in FIGS. 1 and 11, the chain saw 100 further includes a motor support 210. The motor support 210 is clamped by the front end casing 130 and supports the motor 110. The motor support 210 at least includes two support arms 115 arranged crosswise and clamped by the front end casing 130.

The front end casing 130 includes a main casing 136 and an auxiliary casing 137, and the main casing 136 is configured to support the motor 110 and the transmission mechanism 150. The main casing 136 includes the first casing 131 and the second casing 132. The motor support 210 is clamped by the first casing 131 and the second casing 132. The auxiliary casing 137 is configured to cover part of the main casing 136 and the output device 120. The sprocket 153 and part of the chain 122 are disposed between the main casing 136 and the auxiliary casing 137. The transmission mechanism 150 is supported by the main casing 136, and the output shaft 152 extends to a position between the main casing 136 and the auxiliary casing 137 relative to the main casing 136.

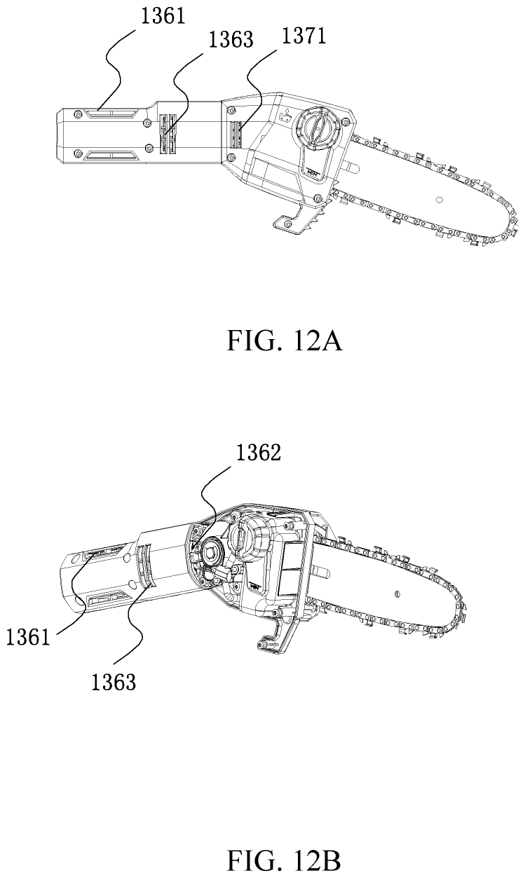

Part of the connection rod 140 is placed in the front end casing 130. As shown in FIGS. 5 and 12, the main casing 136 includes a first air inlet 1361, a second air inlet 1362, and an air outlet 1363. The auxiliary casing 137 includes an outer air inlet 1371. In a radial direction of the first axis 102, a projection of the first air inlet 1361 at least partially overlaps a projection of the connection rod 140, a projection of the second air inlet 1362 and a projection of the outer air inlet 1371 at least partially overlap a projection of the motor support 210, and a projection of the air outlet 1363 at least partially overlaps a projection of the motor 110. Two air inlets are provided so that a supply air rate can be increased, and the position settings of the first air inlet 1361 and the second air inlet 1362 can improve the heat dissipation effect of the motor support 210 and the connection rod 140.

In an example, as shown in FIG. 13, on the premise that a dimension of a motor 310 is reduced, the motor 310 may be disposed at a side end of a connection rod 340. At this time, a projection of the motor 310 and a projection of the connection rod 340 in a direction perpendicular to the first axis partially overlap. A dimension of a front end casing 330 supporting an output device 320 in a direction of the first axis can be reduced, which facilitates the improvement of the balance of the entire machine.

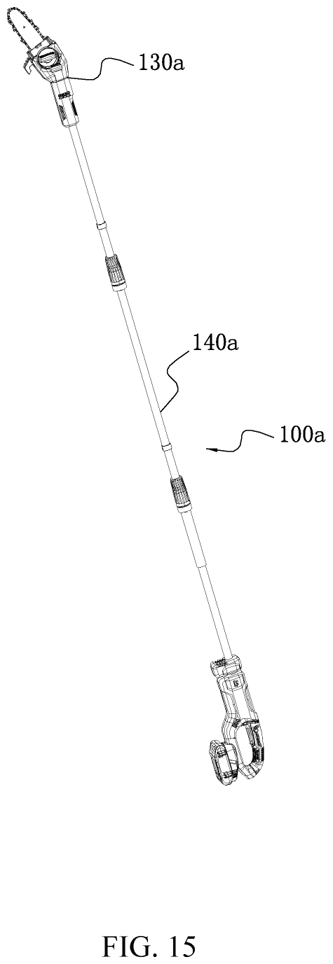

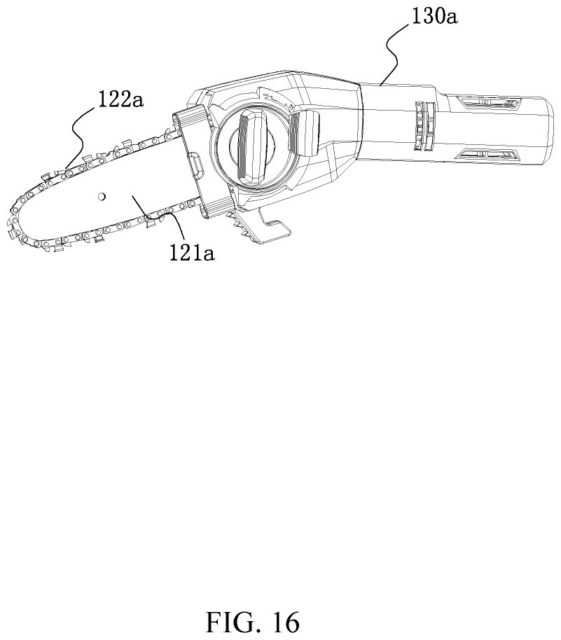

In another example of the present disclosure, referring to FIGS. 15 to 18, a chain saw 100a includes a casing 130a supporting a motor and an output device. The chain saw 100a further includes a chain tensioning element 190a and a locking piece 191a. The cooperation of the chain tensioning element 190a with the locking piece 191a enables a gap between a chain 122a and a guide plate 121a to be adjusted, thereby improving the adaptability of the chain 122a to the guide plate 121a and cutting efficiency.

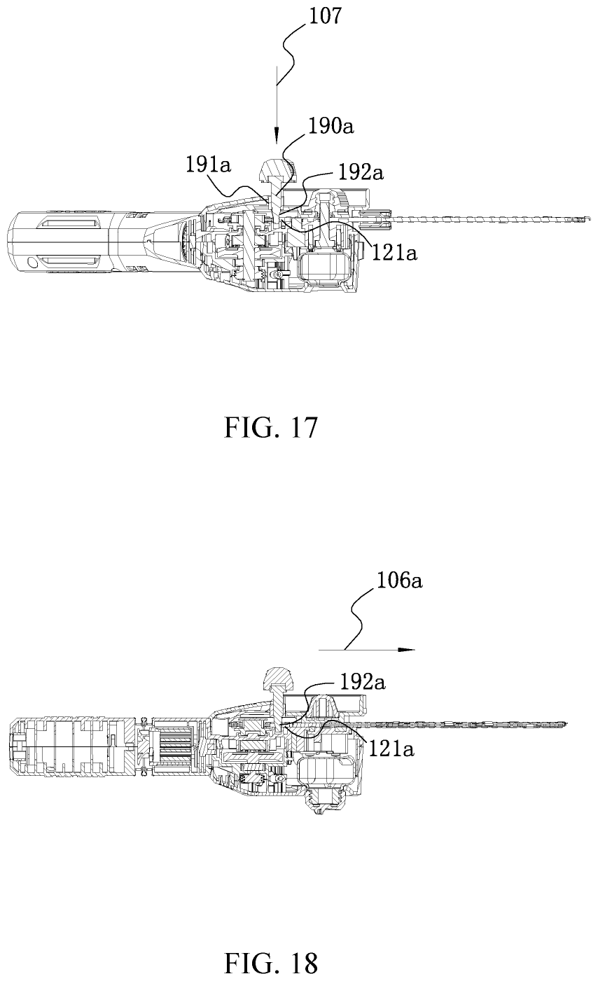

Referring to FIGS. 17 and 18, the locking piece 191a is fixedly connected to the casing 130a, the chain tensioning element 190a can be installed to the locking piece 191a along a first installation direction 107, and the locking piece 191a can fix the chain tensioning element 190a at least to a first installation position and a second installation position. After placed at the first installation position, the chain tensioning element 190a can continue to move to the second installation position relative to the locking piece 191a in the first installation direction 107.

Referring to FIGS. 17 to 19, the chain tensioning element 190a has an adjustment portion 192a that can be in contact with the guide plate 121a, and the adjustment portion 192a has a side surface that can be in contact with the guide plate 121a. When the chain tensioning element 190a is connected to the locking piece 191a, the adjustment portion 192a abuts against the guide plate 121a. When the chain tensioning element is fixed to the first installation position, the adjustment portion has a first section in contact with the guide plate, and when the chain tensioning element is fixed to the second installation position, the adjustment portion has a second section in contact with the guide plate. In a first direction perpendicular to the first installation direction, a dimension of the second section is greater than a dimension of the first section.

In the first installation direction 107, a dimension of the adjustment portion 192a in the first direction 106a perpendicular to the first installation direction 107 gradually increases or decreases, the chain tensioning element 190a moves in the first installation direction 107, and thus the adjustment portion 192a can adjust a tensioning force of the chain relative to the guide plate through a change in a dimension of a position of the adjustment portion 192a in contact with the guide plate 121a. The dimension of the adjustment portion 192a in the first direction 106a may be understood as a length of the adjustment portion in the first direction.

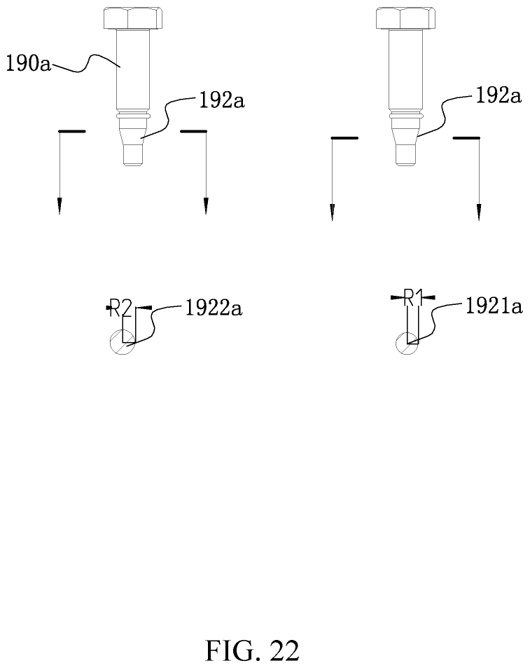

Referring to FIG. 22, when the chain tensioning element 190a is at the first installation position, the adjustment portion 192a has the first section supporting the guide plate 121a. When the chain tensioning element 190a is at the second installation position, the adjustment portion 192a has the second section supporting the guide plate 121a. In the first direction perpendicular to the first installation direction, the dimension of the second section is greater than the dimension of the first section. Optionally, on a plane perpendicular to the first installation direction 107, the first section of the adjustment portion 192a has a first cross section 1921a, and the first cross section 1921a refers to an area enclosed by an edge of the first section in a plane where the first direction is located. The second section of the adjustment portion 192a has a second cross section 1922a, and the second cross section 1922a refers to an area enclosed by an edge of the second section in the plane where the first direction is located. The first cross section has a radius R1, and the second cross section has a radius R2, where R2 is greater than R1, that is, an area of the second cross section is greater than an area of the first cross section so that by adjusting an installation position of the chain tensioning element 190a when connected to the locking piece 191a and an installation depth of the chain tensioning element 190a in the first installation direction 107, the dimension of the position of the adjustment portion 192a in contact with the guide plate 121a can be changed. Optionally, in the first installation direction 107, a cross-sectional area of the adjustment portion 192a perpendicular to the first installation direction 107 gradually increases or decreases.

Optionally, on a plane along the first installation direction 107, the cross-sectional area of the adjustment portion 192a perpendicular to the first installation direction 107 gradually decreases.

For example, when the chain tensioning element 190a is moved from the first installation position to the second installation position, a cross-sectional area of the second section abutting against the guide plate 121a increases relative to that of the first section. In this manner, the guide plate 121a can be driven to move along the first direction 106a so that the guide plate 121a is in full contact with the chain 122a, so as to adjust a tensioning position of the guide plate 121a relative to the chain 122a. When the chain tensioning element 190a is moved from the second installation position to the first installation position, a movable space of the guide plate 121a can be increased, and a gap between the chain 122a and the guide plate 121a can be increased, which makes it easier for the user to take the chain 122a out of the guide plate 121a.

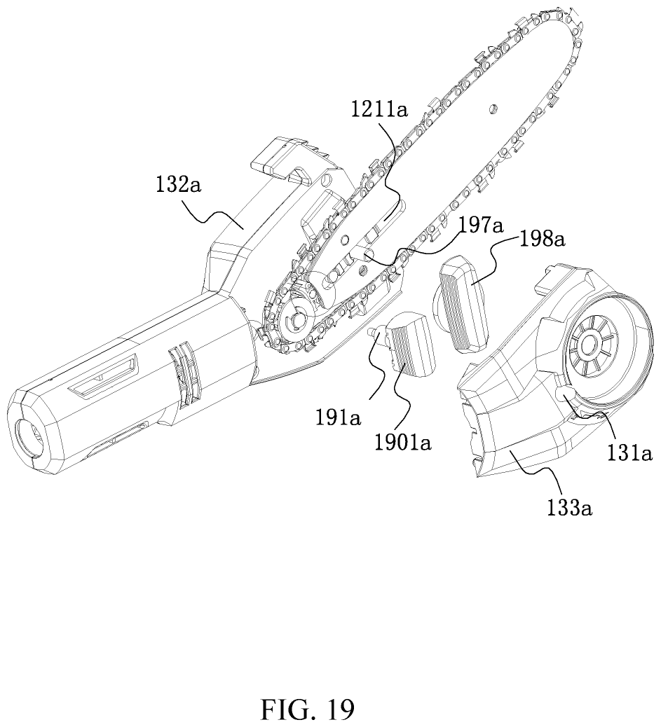

Referring to FIG. 19, the casing 130a further includes an installation hole 131a for limiting the locking piece 191a, the chain tensioning element 190a can pass through the installation hole 131a along the first installation direction 107, and the locking piece 191a is disposed in the installation hole 131a so that when placed in the installation hole 131a, the chain tensioning element 190a can fit with the locking piece 191a to be connected to the locking piece 191a.

The casing 130a includes a main casing 132a and an auxiliary casing 133a. The main casing 132a supports the motor. The auxiliary casing 133a is configured to cover part of the main casing 132a and the output device. The guide plate 121a is positioned between the main casing 132a and the auxiliary casing 133a. The installation hole 131a is formed on the auxiliary casing 133a. Optionally, the installation hole may also be formed on the main casing.

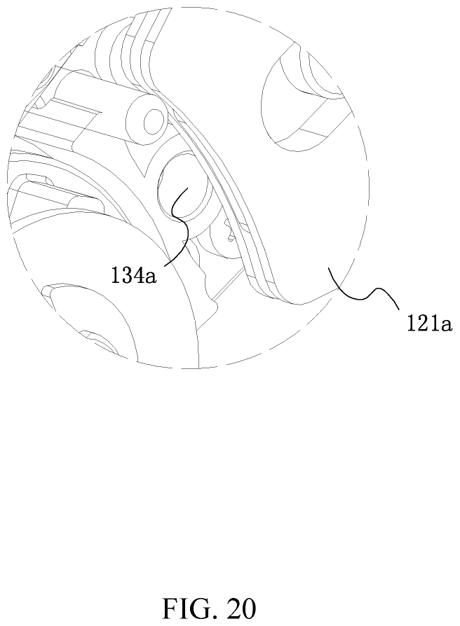

Referring to FIG. 20, the main casing 132a further includes a positioning hole 134a, and the positioning hole 134a is configured to be aligned with the installation hole 131a in the first installation direction 107. The main casing 132a is further configured to fix a sprocket 153a, and the positioning hole 134a is disposed between the sprocket 153a and the guide plate 121a. When the chain tensioning element 190a is installed in the installation hole 131a, an end of the chain tensioning element 190a is placed in the positioning hole 134a, thereby positioning the chain tensioning element 190a and preventing the chain tensioning element 190a from shaking when the chain saw 100a is operating. The chain saw further includes a knob 1901a, the knob 1901a is connected to the chain tensioning element 190a, and the chain tensioning element 190a is moved by the knob 1901a.

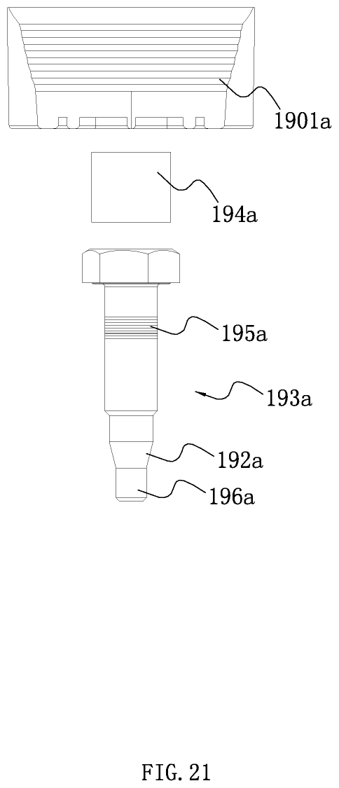

Optionally, referring to FIG. 21, the chain tensioning element 190a is a tensioner bolt 193a, the locking piece 191a is a nut 194a, the adjustment portion 192a is formed on a cylindrical side surface of the tensioner bolt 193a, and the tensioner bolt 193a may be placed in the nut 194a and fixed at least to the first installation position and the second installation position. When the tensioner bolt 193a moves from the first installation position to the second installation position, a distance between the guide plate 121a and the chain 122a in the first direction 106a can be adjusted. Here, the first installation position and the second installation position refer to relative positions of the tensioner bolt 193a. When screwed into the nut 194a, the tensioner bolt 193a can be relatively fixed by the nut 194a to multiple positions in the first installation direction 107, thereby precisely adjusting a tension state of the chain 122a.

The adjustment portion 192a has a conical shape or a truncated cone shape so that the bolt can be placed in the nut 194a along the first installation direction 107 when rotating relative to the nut 194a. A radial dimension of the adjustment portion 192a along the first installation direction 107 gradually decreases. In this manner, when the bolt moves along the first installation direction 107, a conical surface approaches the main casing 132a with the rotation of the bolt, and a dimension of a position of the adjustment portion 192a abutting against the guide plate 121a increases so that the adjustment portion 192a can push the guide plate 121a to move along the first direction 106a. The first installation direction 107 may be perpendicular to the first direction 106a or may be disposed obliquely relative to the first direction 106a.

The tensioner bolt 193a includes a threaded portion 195a, the adjustment portion 192a, and a support portion 196a, and the support portion 196a is configured in a cylindrical shape. The threaded portion 195a threadedly mates with the nut 194a so that the tensioner bolt 193a can be fixed to the first installation position and the second installation position in the nut 194a. When the chain tensioning element 190a is placed in the installation hole 131a, the threaded portion 195a meshes with the nut 194a, the adjustment portion 192a abuts against a side surface of the guide plate 121a, and the support portion 196a is placed in the positioning hole 134a so that after the tensioner bolt 193a is placed in the positioning hole 134a and the installation hole 131a, the tensioner bolt 193a is positioned radially by the positioning hole 134a and the installation hole 131a in the first installation direction and prevented from shaking when the chain saw is operating, so as to stably maintain a current tensioning position of the chain.

The tensioner bolt 193a may be rotated to cause a slight displacement of the tensioner bolt 193a in the first installation direction, and the relative positions of the guide plate and the chain 122a may be adjusted accordingly. The chain tensioning element provided in this example, which has a simple structural design, can improve the adjustment accuracy of the tension of the chain 122a, simplify the entire structure of the chain saw, and reduce the weight of the chain saw, thus reducing the fatigue of the user when operating the chain saw.

The guide plate 121a further includes a center hole 1211a, and the center hole 1211a extends along the first direction 106a. The chain saw 100a further includes a bolt 197a and an operation piece 198a. The bolt passes through the center hole 1211a to provide a pressing force for connecting the guide plate 121a to the main casing 132a, and the operation piece 198a is connected to the bolt 197a to adjust the pressing force provided by the bolt 197a. The bolt 197a is configured to press the guide plate 121a against the main casing 132a in a direction perpendicular to a plane where the guide plate 121a is located. The operation piece 198a rotates the bolt 197a to adjust the pressing force provided by the bolt 197a to the guide plate 121a and the main casing 132a. Optionally, the bolt passes through the auxiliary casing 133a and the center hole 1211a so that the auxiliary casing 133a is bonded to the main casing 132a.

When the user installs the chain, an installation depth of the chain tensioning element 190a relative to the casing 130a is adjusted and thus the gap between the guide plate 121a and the chain is adjusted so that the chain fits with the guide plate 121a and the tension of the chain on the guide plate 121a can be adjusted; the operation piece 198a rotates the bolt 197a so that the guide plate 121a is pressed against the main casing 132a and fixed at a current position.

Optionally, the chain saw provided in this example is a long pole chain saw. In this case, the chain saw includes a connection rod 140a and a handle 171a, and the connection rod is configured to connect the handle to the casing 130a, thereby extending an operable distance of the chain saw.

Optionally, the chain tensioning element is an adjustment nut, and the locking piece is a bolt. The adjustment portion is formed on an outer wall of the adjustment nut. The bolt is fixedly connected to the casing. The nut may be sleeved on a peripheral side of a tensioner bolt and be fixed at least to the first installation position and the second installation position. When the nut moves from the first installation position to the second installation position, the distance between the guide plate and the chain in the first direction can be adjusted.

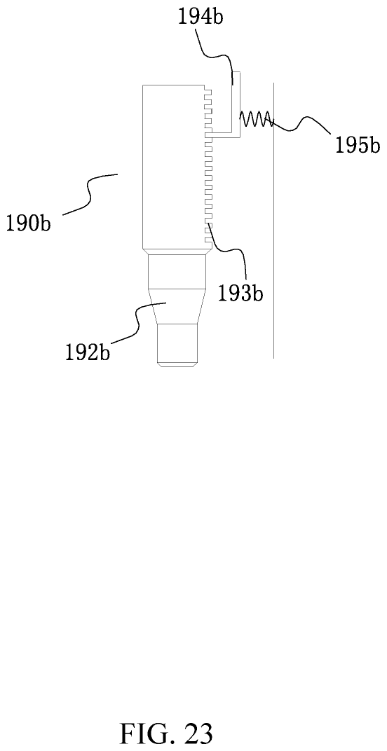

Optionally, referring to FIG. 23, the chain tensioning element 190b is a cylinder, which is provided with a groove portion 193b at one end thereof and has the adjustment portion 192b. The groove portion 193b has multiple grooves evenly arranged. The locking piece 191b includes a spring 194b and a locking pin 195b. The spring 194b biases the locking pin 195b into one groove of the groove portion 193b, and the user presses the locking pin 195b to contract the reset spring 194b so that the locking pin 195b is detached from the groove and thus a depth of the chain tensioning element 190b above the casing can be adjusted; and the locking pin 195b is pushed into another groove by the spring 194b so that the relative tensioning positions of the guide plate and the chain can be adjusted and locked.

The above illustrates and describes basic principles, main features, and advantages of the present disclosure. It is to be understood by those skilled in the art that the preceding examples do not limit the present disclosure in any form, and technical solutions obtained by means of equivalent substitutions or equivalent transformations fall within the scope of the present disclosure.

What is claimed is:

1. A chain saw, comprising:
a connection rod; and
a front end assembly, disposed at a front end of the connection rod, comprising a motor, an output device comprising a guide plate and a chain wound around the guide plate to be driven by the motor, a transmission mechanism configured to connect the motor to the output device, and a front end casing configured to support the motor and the output device;
wherein a ratio of rated output power P of the motor to a maximum weight of the chain saw is greater than or equal to 150 W/kg and less than or equal to 265 W/kg and the motor comprises a rotor shaft configured to rotate around a first axis, a rotor sleeve installed to the rotor shaft and configured to rotate synchronously with the rotor shaft, a stator core disposed at least partially in the rotor sleeve, and a stator coil wound around the stator core.

2. The chain saw of claim 1, wherein the connection rod extends along a second axis, the chain saw has at least a first state, and a ratio of a weight m2 of the front end assembly to a length L1 of the chain saw in a direction of the second axis is greater than or equal to 0.4 kg/m and less than or equal to 0.8 kg/m when the chain saw is in the first state.

3. The chain saw of claim 2, wherein the connection rod comprises a first connection rod and a second connection rod and an extension rod is disposed between the first connection rod and the second connection rod when the chain saw is in the first state.

4. The chain saw of claim 1, wherein a diameter D1 of the rotor sleeve is less than or equal to 38 mm.

5. The chain saw of claim 1, wherein the front end casing comprises a first casing and a second casing, a first accommodation chamber and a second accommodation chamber are formed between the first casing and the second casing, the first accommodation chamber is used for accommodating the motor, and the second accommodation chamber is used for accommodating the transmission mechanism.

6. The chain saw of claim 5, wherein the transmission mechanism comprises a transmission gear driven to rotate by the motor and an output shaft connected to the transmission gear and a diameter D2 of the output shaft is configured to be greater than or equal to 8 mm and less than or equal to 12 mm.

7. The chain saw of claim 6, wherein a transmission ratio outputted by the transmission mechanism is greater than or equal to 3.3 and less than or equal to 5.

8. The chain saw of claim 1, wherein the front end assembly comprises a motor support configured to support the motor and the motor support comprises two support arms arranged crosswise and clamped by the front end casing.

9. The chain saw of claim 1, wherein a projection of the motor and a projection of the connection rod in a direction perpendicular to the first axis partially overlap.

10. The chain saw of claim 1, wherein a weight of the motor is greater than or equal to 1.5 kg and less than or equal to 2 kg.

11. The chain saw of claim 1, wherein a center of gravity of the chain saw is located on the connection rod, the connection rod extends along a second axis, and a maximum distance between the center of gravity and a rear end of the chain saw in a direction of the second axis is greater than or equal to 1100 mm and less than or equal to 1300 mm.

12. The chain saw of claim 1, wherein the connection rod extends along a second axis and the second axis and the first axis are parallel to or coincide with each other.

13. The chain saw of claim 1, wherein the chain saw further comprises a rear end casing and the connection rod connects the front end assembly to the rear end casing.

14. The chain saw of claim 13, wherein a rear end casing comprises a handle for a user to hold and a battery pack interface configured to be connected to a power supply or a battery pack.

15. A chain saw, comprising:
a connection rod; and
a front end assembly disposed at a front end of the connection rod comprising a motor, an output device comprising a guide plate and a chain wound around the guide plate to be driven by the motor, a transmission mechanism configured to connect the motor to the output device, and a front end casing configured to support the motor and the output device;
wherein a diameter of the motor is less than or equal to 38 mm and a ratio of rated output power P of the motor to a maximum weight of the chain saw is greater than or equal to 150 W/kg and less than or equal to 265 W/kg.

16. A chain saw, comprising:
a connection rod; and
a front end assembly disposed at a front end of the connection rod comprising a motor, an output device comprising a guide plate and a chain wound around the guide plate to be driven by the motor, a transmission mechanism configured to connect the motor to the output device, and a front end casing configured to support the motor and the output device;
wherein the motor comprises a rotor shaft configured to rotate around a first axis, a rotor sleeve installed to the rotor shaft and configured to rotate synchronously with the rotor shaft, a stator core disposed at least partially in the rotor sleeve, and a stator coil wound around the stator core, and a diameter D1 of the rotor sleeve is less than or equal to 38 mm.

17. The chain saw of claim 16, wherein the connection rod extends along a second axis, the chain saw has at least a first state, and a ratio of a weight m2 of the front end assembly to a length L1 of the chain saw in a direction of the second axis is greater than or equal to 0.4 kg/m and less than or equal to 0.8 kg/m when the chain saw is in the first state.

18. The chain saw of claim 17, wherein the connection rod comprises a first connection rod and a second connection rod and an extension rod is disposed between the first connection rod and the second connection rod when the chain saw is in the first state.

19. The chain saw of claim 16, wherein the front end casing comprises a first casing and a second casing, a first accommodation chamber and a second accommodation chamber are formed between the first casing and the second casing, the first accommodation chamber is used for accommodating the motor, and the second accommodation chamber is used for accommodating the transmission mechanism.

20. The chain saw of claim 19, wherein the transmission mechanism comprises a transmission gear driven to rotate by the motor and an output shaft connected to the transmission gear, a diameter D2 of the output shaft is configured to be greater than or equal to 8 mm and less than or equal to 12 mm, and a transmission ratio outputted by the transmission mechanism is greater than or equal to 3.3 and less than or equal to 5.
